(19) United States
(12) Patent Application Publication
(10) Pub. No.: US 2007/0055030 A1
(43) Pub. Date: Mar. 8, 2007

(54) Method for the termination of anionic polymerization by Lewis acid

(76) Inventors: Sam-min Kim, Yuseong-gu (KR); Young Jin Kim, Yuseong-gu (KR); Jin Man Hwang, Seo-gu (KR)

Correspondence Address: LAW OFFICES;WHITHAM, CURTIS & CHRISTOFFERSON, P.C., SUITE 340, 11491 SUNSET HILLS ROAD, RESTON, VA, 20190, US

(21) Appl. No.: 11/300,433

(22) Filed: Dec. 15, 2005

(30) Foreign Application Priority Data
Sep. 5, 2005 (KR) 10-2005-0082292

(51) Int. Cl. C08F 4/46

(52) U.S. Cl. 526/173; 526/82

(57) ABSTRACT

The present invention relates to a method for the termination of anionic polymerization by Lewis acid, more particularly, a method for terminating anionic polymerization by employing Lewis acid as a terminating agent to terminate terminally reactive group in the preparation of conjugated diene polymers so that the reaction may be terminated effectively without further couplings, there is no color fading, and it does not require additional neutralization process and a controlling process of pH since any basic product, which reacts with an antioxidant, is not produced.

### FILED OF THE INVENTION

The present invention relates to a method for the termination of anionic polymerization by Lewis acid, more particularly, a method for terminating anionic polymerization by employing Lewis acid as a terminating agent to terminate a terminally reactive end group in the preparation of conjugated diene polymers so that the reaction is terminated efficiently without further couplings, there is no discoloration, and it does not require additional processes of neutralization and pH adjustment because there is no basic product produced, which may react with an antioxidant.

Generally, homopolymers prepared by polymerization of conjugated diene monomers such as butadiene and isoprene, styrene-conjugated diene copolymers prepared by copolymerization of styrenes and conjugated dienes, or block copolymers such as styrene-butadiene-styrene(SBS) block copolymer and styrene-isoprene-styrene(SIS) block copolymer prepared by block polymerization of blocks with an alkali metal containing anionic polymerization initiator in the presence of an organic solvent have been known for highly useful polymers. Especially, block copolymers of styrene and conjugated diene monomers have been usefully employed as an adhesive(SIS) or a modifier(SBS) for asphalt.

After polymerization is completed, the terminal monomer group of the living polymer anion must be terminated in anionic polymerizations. Termination may occur through a coupling reaction with a coupling agent or by the use of suitable proton donating agents such as an organic alcohol, ammonia, amines or even water to terminate the living anion.

Alkali metal organic initiators used in the anionic polymerization are generally highly strong bases and the remnant formed by this termination is also itself a basic species. In the industrial preparation of polymers via anionic polymerization, it is often desirable to include an antioxidant in the polymeric solution to remove a solvent and to prevent oxidative and mechanical degradation of the polymer during the manufacturing process. However, most antioxidants used for such purposes are not stable under a basic condition. That is, under a basic condition the oxidant may be inhibited in its ability to prevent oxidative degradation of the resulting polymer. Consequently, even if the antioxidant is included in the polymeric solution, the resulting product lacks in both color retention and aging stability.

U.S. Pat. No. 5,225,493 discloses that melt viscosity of polymeric products is changed after thermal treatment and further loss of clarity has also found as a result of increased haze.

U.S. Pat. Nos. 4,857,572 and 5,059,661 disclose that when chain-ends of the living copolymer are still reactive or acidity(pH) is not proper, not only heat resistance is decreased but also discoloration of the block copolymer occurs due to undesired reaction of basic species with an antioxidant during addition of the antioxidant. That is, since the antioxidant is very sensitive to reactivity and acidity(pH) of the anionic products, there exists a need for an effective terminating agent or neutralization agent that is sensitive for oxidative and mechanical degradation and thus provide desired effect of antioxidant.

U.S. Pat. No. 4,415,695 proposes to employ boric acid as a terminating agent in an anionic polymerization. Disadvantageously, however, when boric acid is employed as a terminating agent in the preparation of a block copolymer of a monovinylidene aromatic monomer and an alkadiene, the resulting product still possesses an undesirable change in melt viscosity upon thermal aging (U.S. Pat. No. 5,225,493).

U.S. Pat. No. 5,171,791 and 5,225,493 disclose that water or alcohols are used as a terminating agent and sulfuric acid, phosphoric acid or a mixture thereof is used as a neutralizing agent and then antioxidant is added to the polymeric solution in order to resolve the aforementioned problems. However, since alcohols used as the terminating agent and sulfuric acid or phosphoric acid used as the neutralizing agent have poor compatibility with a non-polar solvent utilized as a polymeric solvent, there are several disadvantages that it has difficulty in terminating the reaction quantitatively, it may result in corrosion associated with excess use of a strong acid, and also have difficulty in controlling the acidity.

U.S. Pat. No. 6,174,991 B1 introduces the use of a preferred terminating agent and an antioxidant to stabilize the antioxidant which is added after anionic polymerization. For this purpose, neodecanoic acid is used as a terminating agent and citric acid as a neutralizing agent. The terminating agent used in the above patent is of the formula RCO₂H, where R is C₃ to C₃₀ moiety. Such organic moieties can be recovered by carrying steam coagulation to remove a solvent and thus generate an offensive odor by being remained in the polymer or wastewater by being remaind in water. In addition, it contaminates polymerization solvents as mentioned in U.S. Pat. No. 6,489,403.

U.S. Pat. No. 5,151,475 discloses various terminating agents. According to this patent, although problem associated the reaction termination after anion polymerization is resolved by employing general alcohols, it still causes a problem that excess alcohol impurities are remained since alcohols are used in the form of alkali methoxide. When such excess alcohols and metal oxides are remained in the reactor, they cause deactivation of living polymers in the following reaction so that it may be difficult to control molecular weight. Further, when methanol is used as a terminating agent, most methanol is needed to be removed from a recycling solvent which causes the formation of wastewater. Therefore, a need for novel technologies not producing alkali metal oxide, not using excess alcohols, and efficiently terminating the polymerization is increased and organic compounds able to react with living anions have been developed.

When borane compound, ammonia, and cyclopentadiene are used, they form much of a coupled compound and require a neutralizing agent. When chlorine is used, although less coupled compound is formed, it causes corrosion of the reactor.

U.S. Pat. No. 5,194,530 discloses various organic compounds having activate protons which are then able to react with anions as a terminating agent to terminate the reactive end after anion polymerization. However, it still has problems associated with a coupled compound and requires use of a neutralizing agent, is also returned to its original compound during the recovering process of solvent while neutralization, which have to be removed during the reaction.

### SUMMARY OF THE INVENTION

The present invention has been developed to solve the foregoing problems, and it has been solved by using Lewis acid as a polymerization terminating agent to terminate a terminally reactive group in the preparation of conjugated diene polymers, to remove the neutralization process of a base which inhibits antioxidant's ability of preventing oxidative degradation and discoloration of the polymer, to remove the formation of waster water produced during solvent removing process after neutralization, and to remove mixing of the terminating agent into the recovered solvent.

Therefore, an object of the present invention is to provide a method for terminating anionic polymerization by employing effective and environmentally friendly Lewis acid as a terminating agent in the preparation of conjugated diene copolymers via anionic polymerization to enhance the stability of the resulting polymers.

### DETAILED DESCRIPTION OF THE INVENTION

The present invention provides a method for the termination of anionic polymerization by Lewis acid as a terminating agent in the preparation of conjugated diene copolymers via anionic polymerization.

The present invention is described in detail as set forth hereunder.

The present invention introduces the use of Lewis acid as a terminating agent in the preparation of conjugated diene copolymers via anionic polymerization so that the reaction may be efficiently terminated without further couplings, there may be no discoloration, there may be produced no basic product which inhibits antioxidant's ability, and the acidity may be controlled without an additional neutralization process.

Alternatively, in the preparation of anionic copolymers by using an alkali metal organic compound as an anionic polymerization initiator, the present invention relates to a method for terminating the polymerization by employing Lewis acid to terminate chain-ends of a polymer selected from homopolymers prepared by polymerizing conjugated diene monomers, conjugated diene copolymers prepared by copolymerization of conjugated diene monomers, vinyl aromatic-conjugated diene copolymers prepared by copolymerization of vinyl aromatic monomers and conjugated diene monomers, and block copolymers prepared by copolymerization of vinyl aromatic monomers and conjugated diene monomers in the form of block copolymers.

The anionic polymerization initiators used in the present invention may be alkali metal organic compounds, particularly organolithium compounds. Such organolithium compounds may be any of conventional compounds typically used for the anionic polymerization which are of the formula RLi, wherein R is alkyl, cycloalkyl, aryl and the like containing from 1 to 20 carbon atoms. Examples of preferred the organolithium compounds include n-butyllithium, sec-butyllithium, methyllithium, ethyllithium, isopropyllithium, cyclohexyllithium, aryllithium, vinyllithium, phenyllithium, benzyllithium, and the like.

Vinyl aromatic monomers may be selected at least one from the group consisting of styrene, α-methylstyrene, o-methylstyrene, p-methylstyrene, p-tert-butylstyrene, 1,3-dimethystyrene, alkoxy-substituted styrene, 2-vinylpyridine, 4-vinylpyridine, vinylnaphthalene, and alkyl-substituted vinylnaphthalene, particularly styrene.

Conjugated diene monomers used in the present invention may be selected from the group consisting of 1,3-butadiene, isoprene, piperylene, methylpentadiene, phenyl butadiene, 3,4-dimethyl-1,3-hexadiene, and 4,5-diethyl-1,3-octadiene, which contain 4 to 12 carbon atoms.

Non-polar hydrocarbon solvents used in the present invention may be any conventional solvent known to be used in the anionic polymerization, particularly cyclic aliphatic hydrocarbons such as cyclopentane, cyclohexane or cycloheptane, alkyl-substituted aromatic hydrocarbons such as benzene, naphthalene, toluene, or xylene, and aliphatic hydrocarbons linear or branched pentane, hexane, heptane and the like, especially cyclohexane, n-hexane, n-heptane, and a mixture thereof.

Each step of the polymerization temperature utilized can be same or different, or constant or adiabatic temperature. The polymerization temperature can be within the range of from −10 to 150° C., preferably in the range of from 10 to 100° C.

A terminating agent utilized in the present invention can be any Lewis acid, particularly organomagnesium compounds, organoaluminum compounds, organozinc compounds, and organoborane compounds. Organomagnesium compounds are of the formula MgR¹R², wherein R¹ adnd R² is respectively an alkyl or aryl group. Particularly examples include diethyl magnesium, di-n-propyl magnesium, diisopropyl magnesium, dibutyl magnesium and a mixture thereof.

The organoaluminum compounds utilized as a terminating agent are of the formula AlR¹R²R³, wherein R¹, R² and R³ are independently a hydrogen atom, an alkyl or aryl group. Particularly, the examples include triethyl aluminum, triisobutyl aluminum, tri-n-propyl aluminum, tri-n-hexyl aluminum, diethyl aluminum monohydride, diisobutyl aluminum hydride, and a mixture thereof.

The organozinc compounds utilized as a terminating agent are of the formula ZnR¹R², wherein R¹ and R² are independently an alkyl or aryl group. Particularly, the examples include diethyl zinc, di-n-propyl zinc, diisoamyl zinc, diisobutyl zinc, and the like.

The borane compounds utilized as a terminating agent are of the formula BR¹R²R³, wherein R¹, R² and R³ are independently an alkyl or aryl group. Particularly examples include triethyl borane, tri-sec-butyl borane, tributyl borane, trimesityl borane, triphenyl borane, and the like.

Examples of the anionic polymers reacting with the terminating agent of the present invention include polybutadienes prepared by polymerization of butadiene monomer, polyisoprenes prepared by polymerization of isoprene monomer, butadiene-isoprene copolymers prepared by copolymerization of butadiene and isoprene, styrene-butadiene copolymers prepared by copolymerization of styrene and butadiene, styrene-isoprene copolymers prepared by copolymerization of styrene and isoprene, styrene-butadiene-styrene block copolymers prepared by the block copolymerization of styrene and butadiene, styrene-butadiene-isoprene copolymers prepared by copolymerization of styrene, butadiene, and isoprene, styrene-isoprene-styrene block copolymers prepared by the block copolymerization of styrene and isoprene, and the like.

The present invention is described in more detail with an accompanying example of styrene-butadiene-styrene block copolymers. Although specific examples have been described, the present invention is not limited to these examples. Triblock living copolymers can be prepared by the following steps of preparing a living polystyrene copolymer by adding styrene monomer in the presence of an organolithium initiator and a non-polar hydrocarbon solvent, polymerizing the resulting living polystyrene copolymer with butadiene monomer to provide a diblock living copolymer, and coupling with a coupling agent or polymerizing with additional styrene monomer. When the remnant reactive anions formed after the coupling is terminated or when the polymerization of the triblock copolymer by adding styrene monomers is terminated, the terminating agent described above is added based on equivalents of reactive anion moles to terminate the polymerization and simultaneously neutralize the reactive anion results. After addition of antioxidant, the desired polymer is recovered from the solvent.

Suitably the equivalent ratio of the terminating agent based on the initiator added (i.e. the ratio of equivalents terminating agent/equivalents initiator) is from 0.2 to 20, preferably from 0.5 to 5. If the amount added less than the range, it is insufficient to remove reactive polymers while if the amount is in excess, it causes corrosion due to high acidity.

When such Lewis acids are used as a terminating agent, the reactive polymer produced during the anionic polymerization can be effectively removed since it is highly soluble in a non-polar solvent, and further, pH in the polymer solution can be efficiently controlled. In addition, the use of the Lewis acids as a terminating agent can be useful in the preparation of various polymers using organolithium since the polymerization can be efficiently terminated without couplings, there is no discoloration, and it does not require additional neutralization process because there is no basic product produced, which may reacts with an antioxidant.

The following examples are provided with a view to further illustrating the present invention and should not be construed as limiting the scope of the present invention.

### EXAMPLE 1

### Termination of the Polymerization of Styrene-Butadiene Block Copolymer Using Triethyl Aluminum

A 2L reactor was charged with Argon gas. 900 g of cyclohexane, 0.2 ml of tetrahydrofuran, and 40 g of styrene were placed thereto. The reaction solution was heated to a temperature of 50° C. 2 mmol of n-butyl lithium(1.3M cyclohexane solution) of an initiator was added to the reaction solution. 10 min later after the temperature of the polymerization reached highest, 120 g of butadiene was added to the reaction solution. 5 min later after the temperature of the polymerization of butadiene reached highest, 2 mmol of triethyl aluminum was added to the reaction solution to remove reactive living polymers. Then an antioxidant was added. After the polymerization was completed, 5 g of styrene was additionally added to observe the degree of removing reactive living polymers. The solvent was removed by employing steam stripping from resulting polymer solution to obtain styrene-butadiene block copolymer containing block(s) of styrene-butadiene. The polymer was roll milled to remove any remaining solvent and water.

### EXAMPLE 2

### Termination of the Polymerization of Butadienes Using Triisobutyl Aluminum Hydride

A 2L reactor was charged with Argon gas. 900 g of cyclohexane, 0.2 ml of tetrahydrofuran, and 175 g of butadiene were placed thereto. The reaction solution was heated to a temperature of 50° C. 2 mmol of n-butyl lithium(1.3M cyclohexane solution) of an initiator was added to the reaction solution. 5 min later after the temperature of the polymerization reached highest, 2 mmol of trisobutyl aluminum hydride was added to the reaction solution to remove reactive living polymers. Then an antioxidant was added. After the polymerization was completed, 5 g of styrene was additionally added to observe the degree of removing reactive living polymers. The solvent was removed by employing steam stripping from the resulting polymer solution, roll milled and further dried to obtain polybutadiene.

### EXAMPLE 3

### Termination of the Polymerization of Butadiene Using Triethyl Borane

A 2L reactor was charged with Argon gas. 900 g of cyclohexane, 0.2 ml of tetrahydrofuran, and 175 g of butadiene were placed thereto. The reaction solution was heated to a temperature of 50° C. 2 mmol of n-butyl lithium(1.3M cyclohexane solution) of an initiator was added to the reaction solution. 5 min later after the temperature of the polymerization reached highest, 2 mmol of triethyl borane was added to the reaction solution to remove reactive living polymers. Then an antioxidant was added. After the polymerization was completed, 5 g of styrene was additionally added to observe the degree of removing reactive living polymers. The solvent was removed by employing steam stripping from the resulting polymer solution, roll milled and further dried to obtain polybutadiene.

### EXAMPLE 4

### Termination of the Polymerization in the Form of Styrene-Butadiene Block Using Triethyl Borane

A 2L reactor was charged with Argon gas. 900 g of cyclohexane, 0.2 ml of tetrahydrofuran, and 20 g of styrene were placed thereto. The reaction solution was heated to a temperature of 50° C. 2 mmol of n-butyl lithium(1.3M cyclohexane solution) of an initiator was added to the reaction solution. 10 min later after the temperature of the polymerization reached highest, 120 g of butadiene was added to the reaction solution. 2 min later after the temperature of the polymerization of butadiene reached highest, 20 g of styrene was added for further polymerization. 5 min later after the temperature of the second polymerization of butadiene reached highest, 2 mmol of triethyl borane was added to the reaction solution to remove reactive living polymers. Then an antioxidant was added. After the polymerization was completed, 5 g of styrene was additionally added to observe the degree of removing reactive living polymers. The solvent was removed by employing steam stripping from resulting polymer solution to obtain styrene-butadiene block copolymer containing block(s) of styrene-butadiene. The polymer was roll milled to remove any remaining solvent and water.

### EXAMPLE 5

### Termination of the Polymerization of Butadiene Using Diethyl Zinc

A 2L reactor was charged with Argon gas. 900 g of cyclohexane, 0.2 ml of tetrahydrofuran, and 175 g of butadiene were placed thereto. The reaction solution was heated to a temperature of 50° C. 2 mmol of n-butyl lithium(1.3M cyclohexane solution) of an initiator was added to the reaction solution. 5 min later after the temperature of the polymerization reached highest, 2 mmol of diethyl zinc was added to the reaction solution to remove reactive living polymers. Then an antioxidant was added. After the polymerization was completed, 5 g of styrene was additionally added to observe the degree of removing reactive living polymers. The solvent was removed by employing steam stripping from the resulting polymer solution, followed by roll milled and further dried to obtain polybutadiene.

### EXAMPLE 6

### Termination of the Polymerization in the Form of Styrene-Butadiene Block Using Diisobutyl Zinc

A 2L reactor was charged with Argon gas. 900 g of cyclohexane, 0.2 ml of tetrahydrofuran, and 20 g of styrene were placed thereto. The reaction solution was heated to a temperature of 50° C. 2 mmol of n-butyl lithium(1.3M cyclohexane solution) of an initiator was added to the reaction solution. 10 min later after the temperature of the polymerization reached highest, 120 g of butadiene was added to the reaction solution. 2 min later after the temperature of the polymerization of butadiene reached highest, 20 g of styrene was added for further polymerization. 5 min later after the temperature of the second polymerization of butadiene reached highest, 2 mmol of diisobutyl zinc was added to the reaction solution to remove reactive living polymers. Then an antioxidant was added. After the polymerization was completed, 5 g of styrene was additionally added to observe the degree of removing reactive living polymers. The solvent was removed by employing steam stripping from resulting polymer solution to obtain styrene-butadiene block copolymer containing block(s) of styrene-butadiene. The polymer was roll milled to remove any remaining solvent and water.

### EXAMPLE 7

### Termination of the Polymerization of Butadiene Using Diethyl Magnesium

A 2L reactor was charged with Argon gas. 900 g of cyclohexane, 0.2 ml of tetrahydrofuran, and 175 g of butadiene were placed thereto. The reaction solution was heated to a temperature of 50° C. 2 mmol of n-butyl lithium(1.3M cyclohexane solution) of an initiator was added to the reaction solution. 5 min later after the temperature of the polymerization reached highest, 2 mmol of diethyl zinc was added to the reaction solution to remove reactive living polymers. Then an antioxidant was added. After the polymerization was completed, 5 g of styrene was additionally added to observe the degree of removing reactive living polymers. The solvent was removed by employing steam stripping from the resulting polymer solution, followed by roll milled and further dried to obtain polybutadiene.

### EXAMPLE 8

### Termination of the Polymerization in the Form of Styrene-Butadiene Block Using Dibutyl Magnesium

A 2L reactor was charged with Argon gas. 900 g of cyclohexane, 0.2 ml of tetrahydrofuran, and 40 g of styrene were placed thereto. The reaction solution was heated to a temperature of 50° C. 2 mmol of n-butyl lithium(1.3M cyclohexane solution) of an initiator was added to the reaction solution. 10 min later after the temperature of the polymerization reached highest, 120 g of butadiene was added to the reaction solution. 5 min later after the temperature of the polymerization of butadiene reached highest, 2 mmol of dibutyl magnesium was added to the reaction solution to remove reactive living polymers. Then an antioxidant was added. After the polymerization was completed, 5 g of styrene was additionally added to observe the degree of removing reactive living polymers. The solvent was removed by employing steam stripping from resulting polymer solution to obtain styrene-butadiene block copolymer containing block(s) of styrene-butadiene. The polymer was roll milled to remove any remaining solvent and water.

### COMPARATIVE EXAMPLE 1

### Termination of the Polymerization in the Form of Styrene-Butadiene Block Using Methanol

A 2L reactor was charged with Argon gas. 900 g of cyclohexane, 0.2 ml of tetrahydrofuran, and 20 g of styrene were placed thereto. The reaction solution was heated to a temperature of 50° C. 2 mmol of n-butyl lithium(1.3M cyclohexane solution) of an initiator was added to the reaction solution. 10 min later after the temperature of the polymerization reached highest, 120 g of butadiene was added to the reaction solution. 2 min later after the temperature of the polymerization of butadiene reached highest, 20 g of styrene was added for further polymerization. 5 min later after the temperature of the second polymerization of butadiene reached highest, 2 mmol of methanol was added to the reaction solution to remove reactive living polymers. Then an antioxidant was added. After the polymerization was completed, 5 g of styrene was additionally added to observe the degree of removing reactive living polymers. The solvent was removed by employing steam stripping from resulting polymer solution to obtain styrene-butadiene block copolymer.

### COMPARATIVE EXAMPLE 2

### Termination of the Polymerization of Butadiene in Air

A 2L reactor was charged with Argon gas. 900 g of cyclohexane, 0.2 ml of tetrahydrofuran, and 175 g of butadiene were placed thereto. The reaction solution was heated to a temperature of 50° C. 2 mmol of n-butyl lithium(1.3M cyclohexane solution) of an initiator was added to the reaction solution. 5 min later after the temperature of the polymerization reached highest, the reaction solution was exposed to air to remove reactive living polymers. Then an antioxidant was added. Before the reaction solution was exposed to air, 5 g of styrene was additionally added to observe the degree of removing reactive living polymers. The solvent was removed by employing steam stripping from the resulting polymer solution, followed by roll milled and further dried to obtain polybutadiene.

### COMPARATIVE EXAMPLE 3

### Termination of the Polymerization of Butadiene Using Methanol

A 2L reactor was charged with Argon gas. 900 g of cyclohexane, 0.2 ml of tetrahydrofuran, and 160 g of butadiene were placed thereto. The reaction solution was heated to a temperature of 50° C. 2 mmol of n-butyl lithium(1.3M cyclohexane solution) of an initiator was added to the reaction solution. 5 min later after the temperature of the polymerization reached highest, 2 mmol of methanol was added to the reaction solution to remove reactive living polymers. Then an antioxidant was added. After the polymerization was completed, 5 g of styrene was additionally added to observe the degree of removing reactive living polymers. The solvent was removed by employing steam stripping from the resulting polymer solution, followed by roll milled and further dried to obtain polybutadiene.

### COMPARATIVE EXAMPLE 4

### Termination of the Polymerization in the Form of Styrene-Butadiene Block in Air

A 2L reactor was charged with Argon gas. 900 g of cyclohexane, 0.2 ml of tetrahydrofuran, and 40 g of styrene were placed thereto. The reaction solution was heated to a temperature of 50° C. 2 mmol of n-butyl lithium(1.3M cyclohexane solution) of an initiator was added to the reaction solution. 10 min later after the temperature of the polymerization reached highest, 120 g of butadiene was added to the reaction solution. 5 min later after the temperature of the polymerization of butadiene reached highest, the reaction solution was exposed to air to remove reactive living polymers. Then an antioxidant was added. Before the reaction solution was exposed to air, 5 g of styrene was additionally added to observe the degree of removing reactive living polymers. The solvent was removed by employing steam from the resulting polymer solution, followed by roll milled and further dried to obtain polybutadiene.

### EXPERIMENTAL EXAMPLE

Two methods were used to analyze the ability of Lewis acid as a terminating agent reacting with living polymers; a qualitative method and a quantitative method. A qualitative method wherein, upon completion of the polymerization, additional styrene was added after addition of the terminating agent to the polymer solution. If the reactive polymer is left, the color of the polymer reacted with styrene becomes orange, a particular color of polystyrene. In the other, a quantitative method of gel permeation chromatography (GPC), if the polymer was completely terminated, there would be no indication of high molecular weight on GPC.

Since it was difficult to perform quantitative analysis with the method utilizing color in the present invention, quantitative analysis was conducted using the coupling efficiency. Alternatively, in order to determine the ability of Lewis acid as a terminating agent in the present invention, after Lewis acid was added to the polymer solution prepared by addition of an organolithium into a polymerizable monomer, the polymer solution was reacted for 10 min and exposed to air and then the efficiency of coupling of the terminally reactive group with oxygen was determined with GPC. Coupling efficiency was expressed by percentage where its value is calculated by area of the coupled divided by the total area. The pH meter was used to determine pH of the polymer of which aqueous layer was prepared by dissolving 10 g of a sample of the polymer roll milled in 100 ml of methylene chloride, adding 25 ml of water thereto, and then separating aqueous layer.

Coupling efficiency and pH of the copolymers or polymers of Examples 1 to 8 and Comparative Examples 1 to 4 and color of the polymer solution after adding additional styrene after polymerization was completed are summarized in Table 1.

TABLE 1

| | | Structure | Coupling efficiency (%) | pH | color |
|---|---|---|---|---|---|
| Example | 1 | pS-pB | 4.8 | 7.0 | clear |
| | 2 | pB | 5.6 | 7.2 | clear |
| | 3 | pB | 6.0 | 6.9 | clear |
| | 4 | pS-pB-pS | 5.3 | 7.2 | clear |
| | 5 | pB | 2.5 | 7.0 | clear |
| | 6 | pS-pB-pS | 6.5 | 7.3 | clear |
| | 7 | pB | 3.8 | 7.4 | clear |
| | 8 | pS-pB | 4.6 | 7.0 | clear |
| Comparative | 1 | pS-pB-pS | 6.5 | 10.3 | clear |
| Example | 2 | pB | 24.4 | 9.8 | red |
| | 3 | pB | 5.7 | 10.2 | clear |
| | 4 | pS-pB | 26.8 | 9.7 | red |

As may be seen in Table 1, it is noted that in case of Examples 1 to 8 that utilized Lewis acid as a terminating agent, the polymerization was efficiently terminated with low coupling efficiency, there was no color changing, and the pH was neutral which requires no neutralization process.

As described above, The present invention provides a method for terminating anionic polymerization by employing Lewis acid as a terminating agent to terminate a terminally reactive group in the preparation of conjugated diene polymers so that the reaction may be terminated effectively without further couplings, there is no discoloration, and it does not require additional neutralization process and a controlling process of pH since any basic product, which reacts with an antioxidant, is not produced. Thus, it is suitable for preparing various polymers using organolithium.

1. A method for terminating anionic polymerization using a Lewis acid selected from the group consisting of organomagnesium compounds, organoaluminum compound, organozinc compounds, organoborane compounds, and a mixture thereof in the preparation of conjugated diene polymers by employing an alkali metal organic compound as anionic polymerization initiator.

2. The method for terminating anionic polymerization of claim 1, wherein said conjugated diene polymers are selected from the group consisting of homopolymers prepared by polymerizing conjugated diene monomers, conjugated diene copolymers prepared by copolymerization of conjugated diene monomers, vinyl aromatic-conjugated diene copolymers prepared by copolymerization of vinyl aromatic monomers and conjugated diene monomers, and block copolymers prepared by copolymerization in the form of vinyl aromatic monomer and conjugated diene monomer blocks.

3. The method for anionic polymerization of claim 1, wherein said alkali metal organic compound is an organolithium compound.

4. The method for terminating anionic polymerization of claim 1, wherein said conjugated diene monomer is selected from the group consisting of 1,3-butadiene, isoprene, piperylene, methylpentadiene, phenyl butadiene, 3,4-dimethyl-1,3-hexadiene, and 4,5-diethyl-1,3-octadiene and a mixture thereof.

5. The method for terminating anionic polymerization of claim 2 wherein said vinyl aromatic monomer is selected from the group consisting of styrene, α-methylstyrene, o-methylstyrene, p-methylstyrene, p-tert-butylstyrene and 1,3-dimethylstyrene, and a mixture thereof.

6. (canceled)

7. The method for terminating anionic polymerization of claim 1, wherein said organomagnesium compound is selected from the group consisting of diethyl magnesium, di-n-propyl magnesium, diisopropyl magnesium, dibutyl magnesium and a mixture thereof.

8. The method for terminating anionic polymerization of claim 1, wherein said organoaluminum compound is selected from the group consisting of triethyl aluminum, triisobutyl aluminum, tri-n-propyl aluminum, tri-n-hexyl aluminum, diethyl aluminum hydride, and a mixture thereof.

9. The method for terminating anionic polymerization of claim 1, wherein said organozinc compound is selected from the group consisting of diethyl zinc, di-n-propyl zinc, diisoamyl zinc, diisobutyl zinc, and a mixture thereof.

10. The method for terminating anionic polymerization of claim 1, wherein said organoborane compound is selected from the group consisting of triethyl borane, tri-sec-butyl borane, tributyl borane, trimesityl borane, triphenyl borane, and a mixture thereof.

11. The method for terminating anionic polymerization of claim 1, wherein the equivalent ratio of said Lewis acid is from 0.2 to 20 based on the initiator added.
